(19) United States
(12) Patent Application Publication
(10) Pub. No.: US 2026/0127202 A1
(43) Pub. Date: May 7, 2026

(54) UNIQUE DOCUMENT VARIANTS OF A SOURCE DOCUMENT FOR IDENTIFYING A USER ASSOCIATED THEREWITH

(71) Applicant: Lenovo Global Technology (United States) Inc., Morrisville, NC (US)

(72) Inventors: George-Andrei Stanescu, Popesti-Leordeni (RO); Ajay Dholakia, Cary, NC (US); Eduard Pavel, Constanta (RO)

(21) Appl. No.: 18/939,906

(22) Filed: Nov. 7, 2024

(51) Int. Cl. G06F 16/33; G06F 16/34; G06F 40/166

(52) U.S. Cl. CPC G06F 16/3344; G06F 16/345; G06F 40/166

(57) ABSTRACT

A method and computer program product provide various operations including generating a plurality of unique document variants of a source document, wherein each unique document variant is generated by causing a language model to paraphrase at least a portion of the source document and providing, for each of a plurality of users, a different one of the unique document variants to the user rather than the source document. A plurality of records are stored, wherein each record includes a unique identifier for a particular user and one or more uniquely paraphrased portions of the unique document variant provided to the particular user. If a target document is used in an unauthorized manner, the records may be searched to identify a record in which a uniquely paraphrased portion of the unique document variant is found within the target document and the identity of the user may be output.

### BACKGROUND

The present disclosure relates to method of determining the source of a document leak or other unauthorized use of a document.

### BACKGROUND OF THE RELATED ART

Unauthorized sharing or exposing of a private, confidential, and/or sensitive document of a company or other organization can have severe negative impacts on that organization. These negative impacts may include financial loss, legal liability, damage to reputation or loss of a competitive advantage. In some instances, a document may be unintentionally leaked due to some careless act of a person working within the organization. In other instances, a person within the organization may intentionally leak a document to advance their own agenda or cause damage to the organization. Either way, it may be important to identify the person who leaked the document in order to discover a motive behind the leak and the means and extent of the leak. If this information about the leak can be obtained, then perhaps a future document leak can be mitigated or prevented.

Unfortunately, there is no practical way to guarantee that a person working within an entity, group or organization, such as an employee of a company, will not intentionally or unintentionally expose a confidential document outside the organization or a defined group within the organization. In fact, it could very well be counterproductive to fully restrict the workers within the organization from having access to the document since the information within the document may be necessary for furthering the purpose of the organization. Still, promptly identifying the person that caused the document to be leaked may help limit the impact of the leak and prevent future leaks.

### BRIEF SUMMARY

Some embodiments provide a computer program product comprising a non-volatile computer readable medium and non-transitory program instructions embodied therein, the program instructions being configured to be executable by a processor to cause the processor to perform one or more operations. The operations comprise generating a plurality of unique document variants of a source document, wherein each unique document variant is generated by causing a language model to paraphrase at least a portion of the source document. The operations further comprise providing, for each of a plurality of users that are authorized to access the source document, a different one of the unique document variants to the user rather than the source document, and storing a plurality of records, wherein each record includes a unique identifier for a particular one of the users and one or more uniquely paraphrased portions of the unique document variant provided to the particular user. Still further, the operations comprise obtaining a target document that has been used in an unauthorized manner, searching the plurality of records to identify one of the records in which at least one of the one or more uniquely paraphrased portions of the unique document variant is found within the target document, and outputting identifying information for the user associated with the unique identifier included in the identified record.

Some embodiments provide a method comprising generating a plurality of unique document variants of a source document, wherein each unique document variant is generated by causing a language model to paraphrase at least a portion of the source document. The method further comprise providing, for each of a plurality of users that are authorized to access the source document, a different one of the unique document variants to the user rather than the source document, and storing a plurality of records, wherein each record includes a unique identifier for a particular one of the users and one or more uniquely paraphrased portions of the unique document variant provided to the particular user. Still further, the method comprises obtaining a target document that has been used in an unauthorized manner, searching the plurality of records to identify one of the records in which at least one of the one or more uniquely paraphrased portions of the unique document variant is found within the target document, and outputting identifying information for the user associated with the unique identifier included in the identified record.

### BRIEF DESCRIPTION OF THE SEVERAL VIEWS OF THE DRAWINGS

FIG. 1 is a diagram of a system in which unique document variants are provided to users according to some embodiments.

FIG. 2 is a diagram illustrating the generation of three unique document variants of a single source document for sharing with three authorized users according to some embodiments.

FIG. 3 is a diagram of a computing device according to some embodiments.

FIG. 4 is a flowchart of operations according to some embodiments.

### DETAILED DESCRIPTION

Some embodiments provide a computer program product comprising a non-volatile computer readable medium and non-transitory program instructions embodied therein, the program instructions being configured to be executable by a processor to cause the processor to perform one or more operations. The operations comprise generating a plurality of unique document variants of a source document, wherein each unique document variant is generated by causing a language model to paraphrase at least a portion of the source document. The operations further comprise providing, for each of a plurality of users that are authorized to access the source document, a different one of the unique document variants to the user rather than the source document, and storing a plurality of records, wherein each record includes a unique identifier for a particular one of the users and one or more uniquely paraphrased portions of the unique document variant provided to the particular user. Still further, the operations comprise obtaining a target document that has been used in an unauthorized manner, searching the plurality of records to identify one of the records in which at least one of the one or more uniquely paraphrased portions of the unique document variant is found within the target document, and outputting identifying information for the user associated with the unique identifier included in the identified record.

The source document is a digital file containing text, but which may have additional types of content, such as source code (programming source code such as C, C++, Python, Java, JavaScript and other languages), images and the like. However, the source document preferably includes text in the form of complete statements, such as sentences and/or paragraphs. Short headings, labels, source code, equations, and similar information may technically include text characters or even words but may be difficult to paraphrase without loss of meaning, violation of specific syntax rules, or unintentionally changing references to this information throughout the document. The source document may be stored in any document type or format as long as it can be interpreted by the language model (LLM). Furthermore, the source document may contain portions that are not interpretable or able to paraphrased by the LLM, so long as the source document contains portions that can be interpreted and paraphrased by the LLM.

A document variant of a source document is a document that conveys the same meaning as the source document, but the exact content varies from the source document (i.e., is not an exact copy). A unique document variant is a document variant in which the exact content varies from both the source document and the other document variants formed from the source document. Where the unique document variants are formed by paraphrasing, each unique document variant will contain one or more uniquely paraphrased portions. It should be recognized that a major portion of each unique document variant may be identical to the source document and/or the other unique document variants, but a unique document variant must have one or more uniquely paraphrased portions, such as one or more unique synonyms for a word in the source document and/or one or more uniquely paraphrased sentence or paragraph. In some instances, an entire source document may be paraphrased to form a unique document variant, but it is not necessary to paraphrase the entire source document.

Paraphrasing (i.e., “to paraphrase”) means to restate text in another form while still conveying the same meaning. Paraphrasing may incorporate one or more techniques, such as reformulating a sentence (i.e., changing the grammatical structure of the sentence), changing from active to passive voice, combining information from multiple sentences into one sentence or separating information from one sentence into multiple sentences, changing the order of information, and/or replacing one or more keywords with synonyms (i.e., words that have the same meaning).

A language model (LM) such as a “large language model” (LLM) is a type or artificial intelligence program that is capable performing natural language processing, such as recognizing and generating text. Language models are built on a type of machine learning, such as deep learning using one or more neural networks, that is trained on extremely large sets of data. A language model may be tuned, perhaps through fine-tuning or prompt tuning, to better perform a particular operation or task, such as paraphrasing. Fine tuning may involve additional training on a smaller dataset that is specific to the operation or task that is intended for the language model. Once trained, the language model receives a prompt (i.e., input, instruction, request) and generates a response (i.e., output, answer). In some embodiments, the language model may be provided with the source document and a prompt such as “write four unique document variants by paraphrasing the accompanying source document, where each unique document variant differs from the other unique document variants by three words.” Other prompts may be prepared and used to get the desired unique document variants with or without specifying an extent of the variation between each unique document variant. Non-limiting examples of large language models available over the Internet include ChatGPT (provided by OpenAI), gpt4all (provided by Nomic), Llama (provided by Meta), BERT (provided by Google), and Orca (provided by Microsoft).

Some embodiments of the computer program product may interface with, or be included in, a filesharing application that runs on a filesharing server in a local area network, wide area network or in a cloud computing environment. The filesharing software may provide a user interface that facilitates user access to source documents stored on a data storage device. The user interface may support various functions, such as user uploading and storing a source document, one or more user editing and/or contributing to a source document, and one or more user accessing the source document. Filesharing is the practice of distributing or providing access to digital media, such as documents or computer programs. One non-limiting example of filesharing software is Microsoft OneDrive/SharePoint. OneDrive/SharePoint is a web-based collaborative platform that features a document management and storage system but may also be used for sharing documents through an intranet. Other non-limiting examples of a cloud-based filesharing service include Box, Google Drive, iCloud, Slack and Dropbox. Regardless of the location or environment in which the filesharing software is located, the filesharing software should logically reside between a data storage device or facility and a user interface that allows a user to access the document. For example, the operations of one or more embodiments may be implemented in the filesharing software application or in conjunction with the filesharing software application and the user interface.

The plurality of users authorized to access the source document may have credentials that show or enable their authorized access to the source document, a folder containing the source document, and/or the entire contents of the fileserver. Such user credentials may include a username and password combination, or other types of credentials. Optionally, an administrator of the filesharing application or an author of the source document may designate which users are authorized to access the source document.

A “unique identifier” of a user may include a login ID/password combination for accessing the filesharing application, an Internet Protocol (IP) address of a user device, a Media Access Control (MAC) address of a user device, and/or personal biometric input such as a fingerprint, face image, voice sample, or iris image. For example, a user may receive or obtain a user account requires the user utilize some sort of unique identifier, such as a username. The unique identifier from a user account, such as with filesharing software, may be utilized in some embodiments to identify a user and associate with a unique variant of the document that is provided to the identified user. In a further option, the unique identifier could be hidden from the user, such as an employee identifier that is not communicated with the employee. Alternatively, the unique identifier of a user could be derived as a hash of one or more type of information associated with the user, such as a hash of the user's email address, username, and/or biometric data. However, whatever type of unique identifier is stored in association with the unique document variant provided to the user, such unique identifier is preferably included in a user profile containing additional information about the user. The user profile may include various identifying information for the user which may be useful in identifying the person, such as the user's full name, address, phone number, email address, job title. Accordingly, the unique identifier that is associated with the unique document variant may also be associated with a specific user profile.

An unauthorized use of a document may, for example, include leaking (i.e., unauthorized disclosure) of a confidential document to others that are not authorized to access the document. When it is discovered that a target document has been used in an unauthorized manner and a copy of that target document has been obtained, embodiments may search the plurality of records to identify one of the records in which the one or more uniquely paraphrased portions of the unique document variant is found within the target document. The identifying information for the user associated with the unique identifier included in the identified record may then be output. Accordingly, even where the unauthorized use of the document is an anonymous publication of the document or sharing the document with an unauthorized person, the one or more uniquely paraphrased portions of the target document can be traced back to the user that was provided with the unique document variant containing those one or more uniquely paraphrased portions. Even if the unauthorized use of the document was the result of a security breach in which the document was taken and used in an unauthorized manner due to no malicious intent of the user, it may be important to identify the user so that training or security systems involving that user may be addressed to avoid any further breach.

Some embodiments include the operation of searching the plurality of records to identify one of the records in which the one or more uniquely paraphrased portions of the unique document variant are found within the target document. Optionally, this operation may more specifically include searching the plurality of records to identify one of the records in which the unique document variant matches the target document. While it is sufficient for some embodiments to identify a record with the one or more uniquely paraphrased portions, the amount of the content from the unique document variant that must match the target document may vary all the way up to a requirement that the entire document be identical. Still, the one or more uniquely paraphrased portions is what uniquely associates this unique document variant with one of the users and is sufficient for identifying the user who caused, allowed or enabled the unauthorized use of the document. Intentional modification of other portions of the document will not prevent identification of the user so long as the one or more uniquely paraphrased portions remains in the document. Clearly, a unique document variant have a greater number of uniquely paraphrased portions is more likely to withstand intentional modification efforts and still have at least one uniquely paraphrased portion that allows identification of the associated user. However, some embodiments may be implemented in a manner that the users themselves are unaware that they are being provided with a unique document variant. Accordingly, the number of uniquely paraphrased portions may be kept low so that users are less likely to become aware that they received a variant of the source document rather than the source document itself. A user that is unaware that they received a unique document variant is unlikely to take steps to modify the document prior to the unauthorized use.

In some embodiments, the source document may be stored on a data storage device and made accessible to the plurality of users. For example, the plurality of users may have accounts to a filesharing application that uses the data storage device. Accordingly, the plurality of users each have their own credentials allowing them to create, edit and store a source document on the data storage device via the filesharing application. In some instances, the filesharing application may enable multiple users to collaborate on a source document such that each of the users may add, delete, edit, or make other changes to the source document. In some embodiments, when user input requesting access to the source document is received from a given user among the plurality of users, one of the unique document variants is provided to the given user rather than the source document. The operation of providing the given user with one or the unique document variants rather than the source document is preferably performed automatically with no user involvement and is preferably not detectable to the given user or any of the users. For example, the user may receive access to one of the unique document variants by using existing commands or gestures to indicate an intention to access the source document. The commands or gestures may, for example, be known commands or gestures for opening/viewing the document (i.e., double left click over a document icon) or commands or gestures for copying/downloading/storing the document (i.e, right click followed by selection of copy from a drop down context menu). In one option, a user interface is formed to enable any of the plurality of users to submit the user input, wherein the one of the unique document variants is provided to the given user by downloading the unique document variant to a computing device operated by the given user. Embodiments may detect the user's commands or gestures involving the source document, generate a unique document variant or verify that a unique document variant has already been prepared for this user, and provide the unique document variant to the user in a manner responsive to the command or gesture. Of course, if other settings prevent the document from being copied/downloaded/stored by the user, then such a restriction should be honored.

In some embodiments, the unique document variant that is provided to the given user is generated in response to receiving the user input that requests to access the source document. In other words, the unique document variant is not generated until it is needed to be provided to the user. In other embodiments, the plurality of unique document variants of the source document, including one unique document variant for some or all of the plurality of users that are authorized to access the source document, may be generated without receiving user input from each of the plurality of users. In other words, the unique document variants are generated in anticipation of eventually being provided to the plurality of users. The unique document variants, or at least the one or more uniquely paraphrased portions of the unique document variants, are stored and made available to the corresponding users at a later time when the users request such access to the source document. In one example, the language model may be provided with the source document, the number of users (“X”) that are authorized to have access to the source document, and a prompt requesting X unique document variants of the source document having one or more uniquely paraphrased portions. The language model will then generate an equal number of X unique document variants and assign one of the unique document variants to be provided to each user. A record may be stored that associates a user's unique identifier with a complete copy of the unique document variant provided to the user, the one or more uniquely paraphrased portions of the unique document variant provided to the user, or only the differences between the unique document variant and the source document.

In some embodiments, the operations may further comprise storing the source document on a data storage device and receiving user input requesting that the source document be sent to one or more of the plurality of users, wherein, for each of the one or more users, a different one of the unique document variants is provided to the user by sending the one of the unique document variants in an electronic message. Without limitation, the electronic message may be an email message or a direct message.

Some of the embodiments may generate the unique document variants from a source document having “read-only” permissions, such that the users do not have permission to edit the document. This simplifies the objective of generating unique document variants since the source document itself is not subject to being changed. However, some other embodiments may be implemented in the context of a source document that is still subject to occasional change, such as one or more revisions being made by one or more of the users. In this latter case of a dynamically changing source document, the unique document variants may need to be revised to reflect the revisions being made to the source document and/or it may be necessary to generate one or more new unique document variants to maintain the uniqueness of each document variant at all times. In one example, if a source document is revised by a user such that a particular paragraph is deleted, then the original paragraph, as well as any paraphrasing of the original paragraph, must be removed from all of the unique document variants. If any of the unique document variants relied on that specific paragraph being paraphrased in a unique way to provide the uniqueness of the unique document variant, then that unique document variant will no longer be unique after removing the deleted paragraph and a new unique document variant must be generated via paraphrasing. If the revisions to the source document are directly solely to a non-unique portion of a unique document variant, then the revisions should be reflected in an update to the unique document variant, but those revisions will not eliminate the unique portion of the unique document variant and it is not necessary to generate a new unique document variant. Depending upon the particular portions of the source document that are revised, there may be none, some or all of the previously generated unique document variants that require regeneration.

Embodiments may store records or entries that identify which one of the unique document variants was provided to which one of the users who accessed the document. In one option, a data structure may store either a complete copy of the document variant provided to the user or a partial copy of the document variant that contains unique content suitable to identify the document variant from other document variants. Since the unique content of the complete or partial copy of the document variant is associated with a unique identifier for a user, the presence of the unique content in the document variant will identify the user that was provided with that document variant. In another option, the data structure may store the differences between the source document and the document variant that was provided to the user. For example, if a single word in the source document was replaced with a synonym in the unique document variant, then the record might store the synonym (i.e., the new word) and the location within the document where the replacement/variation/modification was made (i.e., line number and character number or word number within the line). In a further option, if the unique document variation was generated from the source document using a seed value input into an algorithm to form the individual variations/modifications to the source document, then the data structure may store the seed value and some reference to the algorithm and source document. Accordingly, the unique document variant that was provided to a given user may be regenerated from the seed value, algorithm, and source document whenever the unique document variant is needed for comparison with a target document that was leaked or otherwise used in an unauthorized manner in order to identify the user that was provided with that unique document variant. Optionally, each stored record may further include a timestamp identifying the time and data at which the unique document variant was provided to the given user.

In a further option, one or more of the records may include a hash of the unique document variant. A leaked document (i.e., target document) can therefore be checked against the database of records by creating a hash of the target document, locating the record containing a matching hash, then identify the user identified within that record as the source of the target document. The use of the hash values may simplify the comparisons and accelerate the locating of the relevant record because a hash of a given document may be significantly smaller than the actual document itself. In one alternative, the hash of a unique document variant may be calculated whenever a comparison needs to be made.

In some embodiments, the plurality of unique document variants of the source document may be generated by providing a seed value to an algorithm that uses the seed value to produce an output that is then used to control how the language model with paraphrase the source document. If the algorithm and the language model are both deterministic, then it is only necessary to store the seed value in the record for the unique document variant. The seed value can always be used in combination with the algorithm and language model to generate the unique document variant, or at least the one or more uniquely paraphrased portions of the unique document variant, as needed.

In one non-limiting example, the equation below represents an individual unique document variant (“DocumentVariantᵢ”) may be formed using a paraphrasing function (“Paraphrase”) of a language model based on the source document (“Document”), the individual's user identifier (“UIDᵢ”), a particular language model such as a particular large language model (“LLM”), and some measure of a desired granularity of paraphrasing (“Granularity”). Other parameters may also be considered.

$${DocumentVariant}_{i} = Paraphrase ( Document , {UID}_{i} , LLM , Granularity , … )$$

In one option, the UID for a given user may be an integer value or may be converted to an integer for used as a seed to a random generator function which is instructed to output integers within the range from 1 to the number of words in the document. This randomly generated integer may identify the word that should be replaced with a synonym or the sentence or paragraph that should be paraphrased. Optionally, collisions can be avoided or mitigated by using various techniques, such as hash-table collision avoidance techniques such as probing, chaining, and double hashing.

In some embodiments, the operations may further comprise tracking, for any of the plurality of users that contributed to the source document, one or more portions of the source document that are contributed by the user. Accordingly, the operation of generating the plurality of unique document variants of the source document may include generating, for each of the plurality of users that contributed to the source document, the unique document variant provided to the user by causing the language model to paraphrase only those portions of the source document that were contributed by another user. In other words, the generation of a unique document variant to be provided to a given user will avoid paraphrasing any portion of the collaborative document that is attributable to the given user. Limiting the paraphrasing to portions attributable to other users may be preferred because each user may be less likely to detect changes in portions of the document that were written by others.

In some embodiments, the operations may further comprise forming a digital signature for each unique document variant. Accordingly, the operation of providing, for each of a plurality of users that are authorized to access the source document, a different one of the unique document variants to the user rather than the source document may include providing the digital signature to the user along with the unique document variant. The digital signature would certify that the unique document variant originated with the filesharing server or application (presumably operated by a known organization). The use of a digital signature in this manner would prevent a user who leaked the document from modifying the document variant (perhaps using a similar paraphrasing software) outside of the filesharing platform and still claim that the leaked document came from the filesharing server or application. Specifically, a hash of the leaked document (i.e., a twice-paraphrased document variant) would not match the hash obtained by decrypting the digital signature with the public key of the filesharing server, application or operating entity. Accordingly, the leaked document would show evidence of tampering and would not be credible as a document generated by the entity operating the filesharing server.

If the target document is obtained in a digital form, then the target document or a hash of the target document may be compared to each unique document variant or the hash of each unique document variant stored in the database. Once the filesharing software identifies a record having a hash that matches the hash of the leaked document or at least a unique paraphrased portion of the unique document variant that matches the target document, then that record will identify the user that leaked the document. In alternative embodiments, if the target document is obtained in a printed or image form, then the leaked document may be converted to a digital form (perhaps using optical character recognition (OCR)) for a direct comparison or a hash-based comparison to the unique document variants in the records.

Some embodiments may further comprise determining an extent to which the source document will be paraphrased during the operation of generating of the one or more of the document variants. For example, the extent to which the source document is paraphrased may be based upon the number of users that are authorized to access the source document, a level of confidentiality assigned to the source document, and/or a probability that the source document will be used in an unauthorized manner. Accordingly, the operation of causing the language model to paraphrase at least a portion of the source document may include instructing the language model to paraphrase the at least a portion of the source document to the determined extent. Without limitation, the extent to which the source document is modified may vary. For example, a document variant might differ from the source document by a word, sentence, phrase, paragraph, or entire document, depending on the circumstances. Where a single word in a given sentence is modified, one such modification may be a synonym for the word being replaced. The part of the document that is paraphrased can be selected based on a certain algorithm or at random.

In some embodiments, the extent of variation between the source document and each unique document variant and/or the manner in which each unique document variant is modified may be configurable by administrative personnel or the person creating, finalizing, presenting or adding the source document on the filesharing platform for access by the other users. Alternatively, embodiments may automatically vary the extent and/or manner of variation in each unique document variant. For example, the software may automatically and dynamically determine the extent and/or manner of variation in a unique document variant based on various conditions or input such as the number of users who are authorized to access the source document, a document confidentiality classification (sensitive, highly confidential, secret . . . ), individual user parameters or scores (i.e., individual or collective parameters reflecting the probability of the user leaking the document). Such individual user parameters may include the user's length of relevant history with similar documents, number of intentional and/or unintentional document leak incidents, whether the user is up-to-date with a company's mandatory security trainings, or lack of history for a new user/employee. It may be preferable to use administrator and/or automatic configuration of the extent and/or manner of variation since users are preferably kept unaware that they are receiving a document variant rather than the actual source document. User awareness that they have received a document variant may tip off an intentional leaker that they should take steps to scrub the document in a manner that might thwart the leak identification process.

In some embodiments, the extent and/or manner of variation could be automatically varied or configured based upon a measure of the level of interaction among the users that are authorized to access the source document. Optionally, if the user have a high level of interaction (i.e., open discussion, sharing, comparing), then variations between document variants are more likely to be detected by the user. So, to avoid detection of the fact that unique document variants are being provided to the users, the extent and/or manner of variations or modifications in each unique document variant should be less detectable by the users. For example, if a group of users authorized to access the source document are expected to have a high level of interaction, then the variations or modifications caused by paraphrasing may be limited to smaller strings, such as a one or more sentence or one or more word, and any additional modifications may be non-print characters (i.e., spaces, indentation and margins). If the group of users having access to the document are instructed not to discuss the source document or if each of the users in the group are event unaware of the identify of other users authorized to access the source document, then the leak detection application may increase the extent and/or manner of paraphrasing and/or other variations or modifications with less potential for user detection that they have been provided with a document variant. Optionally, a level of interaction among a group of users having access to the document may be determined based upon one or more parameters, such as the nature of any relationship between them, their relative geographic location or distance of separation, and/or a frequency of communication between users (i.e., calls, video calls, text messages, emails). In a specific example, assume that a document may be shared with 20 people (users) and 10 of them work for the same manager (i.e., a close, regular working relationship), while the other 10 people each work for different managers (i.e., no specific ongoing relationship). In this example, embodiments could decide to do light (i.e., a low extent) paraphrasing for those 10 users who are in the same work group and moderate to heavy paraphrasing for those 10 users who each have different managers (i.e., none of the second 10 users have the same manager). In some embodiments, relationship information that could be used to measure a level of interaction between users may be obtained from third party applications, such as social media. For example, where three users authorized to access the source document are friends on a social media platform and their social media accounts include evidence that they spend vacations together, then this information could form the basis to expect a high level of interaction generally, and a high likelihood of discussing this document. Accordingly, embodiments may generate document variants for these three users that have only light paraphrasing (i.e., a low extent of paraphrasing).

In some embodiments, the operations may include determining the total number of words in the source document and randomly generate a number (N) between one and the total number of words in the source document. Then, the operation of causing the language model to paraphrase at least a portion of the source document may include causing the language model to replace the Nth word in the source document with a synonym, paraphrase the sentence that includes the Nth word in the source document, and/or paraphrase the paragraph that includes the Nth word in the source document.

Some embodiments may further comprise establishing a similarity threshold between the unique document variants, determining a similarity index or measurement between a plurality of pairings of the unique document variants, and causing, in response to one of the pairings of the unique document variants having a similarity index greater than the similarity threshold, the language model to further paraphrase one or more of the unique document variants in the pairing. This process of further paraphrasing one or more of the unique document variants may be repeated until the similarity index for the current document variant is less than the similarity threshold. Document similarity may be measured in various ways, such as the Euclidean Distance, and may be expressed as a numerical value that can be transformed to a percentage.

Some embodiments may implement a minimum or maximum similarity threshold for the similarity between the multiple document variants generated from a given source document. Specifically, a high level of similarity would indicate a document variant that is highly similar to the source document (i.e., few modifications) and a low level of similarity would indicate a document variant that is highly differentiated from the source document (i.e., numerous modifications). For example, a unique document variant with high similarity to the source document may be generated by providing the paraphrasing software (i.e., a language model) with a prompt specifying a high similarity threshold as a minimum level of similarity, such that each of the resulting unique document variants will have greater similarity to the source document than the similarity threshold. Conversely, a unique document variant with low similarity to a source document may be generated by providing the paraphrasing software (i.e., a language model) with a prompt specifying a low similarity threshold as a maximum level of similarity, such that each of the resulting unique document variants will have less similarity to the source document than the similarity threshold.

Some embodiments may combine the paraphrasing process with one or more additional document modification process to generate the document variant. For example, a document variant may be generated by paraphrasing some portion of a source document and digitally watermarking the document. Digital watermarking embeds hidden information into a document. Other document modification processes that may be used in combination with paraphrasing include modification of the metadata associated with the unique document variant, insertion of intentional mistakes/typos into the document variant, making slight changes in text color, using of invisible/unprintable/non-image characters such as extra spaces, encoding a UID into the document by using spaces between words, and or using homoglyphs. Optionally, the additional document modifications may be implemented after the paraphrasing operation, in which case the additional document modifications may be used in a conventional manner.

Some embodiments provide a method comprising generating a plurality of unique document variants of a source document, wherein each unique document variant is generated by causing a language model to paraphrase at least a portion of the source document. The method further comprise providing, for each of a plurality of users that are authorized to access the source document, a different one of the unique document variants to the user rather than the source document, and storing a plurality of records, wherein each record includes a unique identifier for a particular one of the users and one or more uniquely paraphrased portions of the unique document variant provided to the particular user. Still further, the method comprises obtaining a target document that has been used in an unauthorized manner, searching the plurality of records to identify one of the records in which at least one of the one or more uniquely paraphrased portions of the unique document variant is found within the target document, and outputting identifying information for the user associated with the unique identifier included in the identified record.

In some embodiments, the method may further comprise automatically modifying a network or server access permission or setting for the user associated with the unique identifier included in the identified record. Accordingly, the identified user may be prevented from further access to the source document or other source documents, or otherwise be limited in the extent of their use or privileges on the network and/or the filesharing server or service where the source document is located.

The foregoing method may further include any of the operations or aspects of the computer program products described herein. Similarly, the foregoing computer program products may further include program instructions for implementing or initiating any one or more operations or aspects of the methods described herein.

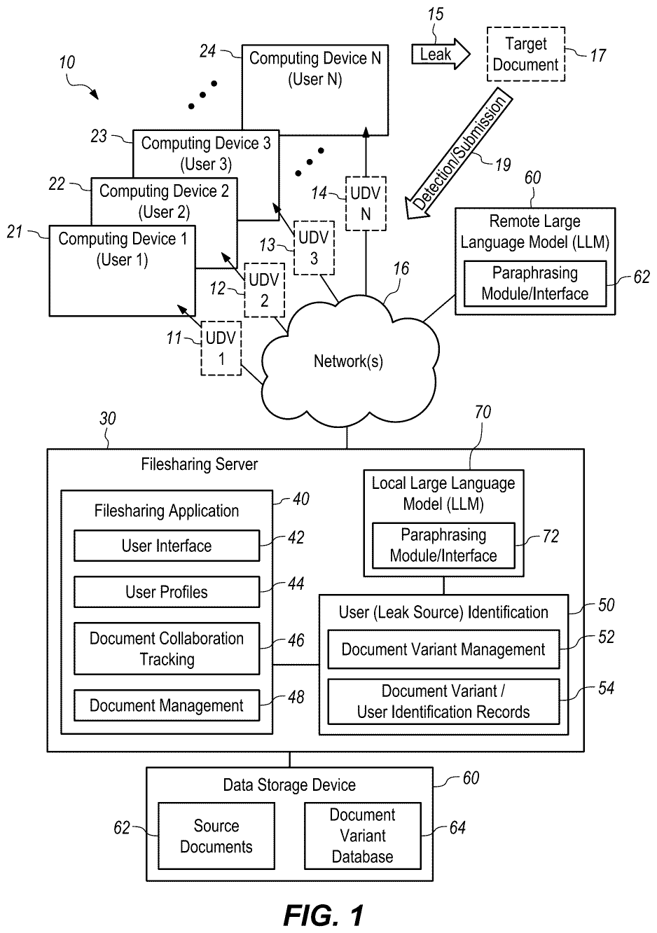

FIG. 1 is a diagram of a system 10 in which unique document variants 11-14 are provided to users' computing devices 21-24 according to some embodiments. In the system 10, the users' computing devices 21-24 are able to connect with a filesharing server or service 30 over one or more networks 16, such as a local area network and/or a wide area network like the Internet.

The filesharing server or service 30 performs a filesharing application 40 and user (leak source) identification application or logic 50. The filesharing server or service 30 is connected to, or otherwise has access to, a data storage device 60 which may be a discrete data storage device or a data storage service such as cloud storage.

In the illustrated embodiment, the filesharing application 40 provides a user interface 42 that facilitates interaction with the users of the computing devices 21-24. For example, the user interface 42 may be a graphical user interface that presents one or more icon or other indicator suggesting that one or more source documents are accessible to the users and allows users to interact with the filesharing application 40 to, for example, create, edit, store and access one or more source documents 62 on the data storage device 60. Each user may have an individual user profile created and stored in the user profiles 44 of the filesharing application 40. In addition to storing user identifiers and contact information about each user and/or each user computing device 21-24, the user profiles 44 may indicate each user's authorization to access particular source documents 62. A document collaboration tracking module 46 may enable collaborative development of the source documents 62, track changes made to the source document and attribute each change to the user that made the change to the source document. Accordingly, the collaboration tracking module 46 can identify each portion of a source document that was contributed by each user. A document management module 48 may provide an interface with the data storage device 60 and manage reading/accessing and writing/storing of the source documents.

The user (leak source) identification application or logic 50 may be separate from, or included in, the filesharing application 40, but communicates with aspects of the filesharing application 40 and either a remote large language model (LLM) 60 and/or a local large language model (LLM) 70. The user (leak source) identification application or logic 50 includes a document variant management module 52 and a document variant/user identification records module 54.

The document variant management module 52 may receive input from the user interface 42 indicating that a user has requested access to one of the source documents 62. For example, the user interface 42 may receive input indicating that the user has clicked on or selected an icon or other indicator that suggests or otherwise conveys to the user that a source document 62 is available for viewing or downloading. In accordance with some embodiments, the document variant management module 52 may then cause the remote or local large language model (LLM) 60, 70 to generate a unique document variant of the requested source document. For example, the remote or local LLMs 60, 70 may include a paraphrasing module or functionality/interface 62, 72 that generates the unique document variants. Specifically, the document variant management module 52 may send the source document and a prompt to one of the LLMs 60, 70, where the prompt requests paraphrasing of at least a portion of the source document. The document variant management module 52 may keep track of each document variant and compare them to verify that each document variant generated by the LLM is in fact a “unique” document variant. Accordingly, the unique document variant may be provided to the user rather than the actual source document (that is, rather than the source document suggested by the icon or other indicator that the user clicked on or selected). Then, the document variant/user identification records module 54 will store a record in which the identity of the specific unique document variant is associated with the identity of the user that was provided with that unique document variant. The content of the unique document variants may be stored in the document variant database 64 on the data storage device 60. Furthermore, the records that associate each unique document variant with a unique user identifier for the user that received the unique document variant may also be stored in the document variant database 64 or other data structure stored on the data storage device 60 or other data storage.

At some later point in time, it is possible that one of the users may leak their unique document variant (see “leak” arrow 15). This could happen by intentionally sharing the document with an unauthorized person, intentionally publishing the document, or even by unintentionally through the actions of a hacker. The leaked document is referred to herein as a “target document” 17 because it is not immediately known which document variant was leaked or which user leaked the document. However, once the leaked target document 17 is detected, a copy of the target document 17 should be submitted to the filesharing server 30 (see “detection/submission” arrow 19).

Within the filesharing server or service 30, the content of some or all of the target document 17 may be used to identify the user that was involved in the leak of the target document. In one example, one or more uniquely paraphrased portions of each unique document variant stored in the document variant database 64 may be compared with the relevant portions of the target document. If one or more uniquely paraphrased portions of a unique document variant is found in the target document, then the record of the document variant/user identification records module 54 identifying that unique document variant will also identify the user that was provided with that unique document variant. Accordingly, the user and user's computing device may be investigated to determine the circumstances leading to the leak of the target document or access from the user or the user's computing device to the filesharing server 30 may be prevented or controlled (e.g., by modifying a network or server access permission or setting). When the leak was intentional or unintentional, identifying the source of the leak may be beneficial to preventing further leaks.

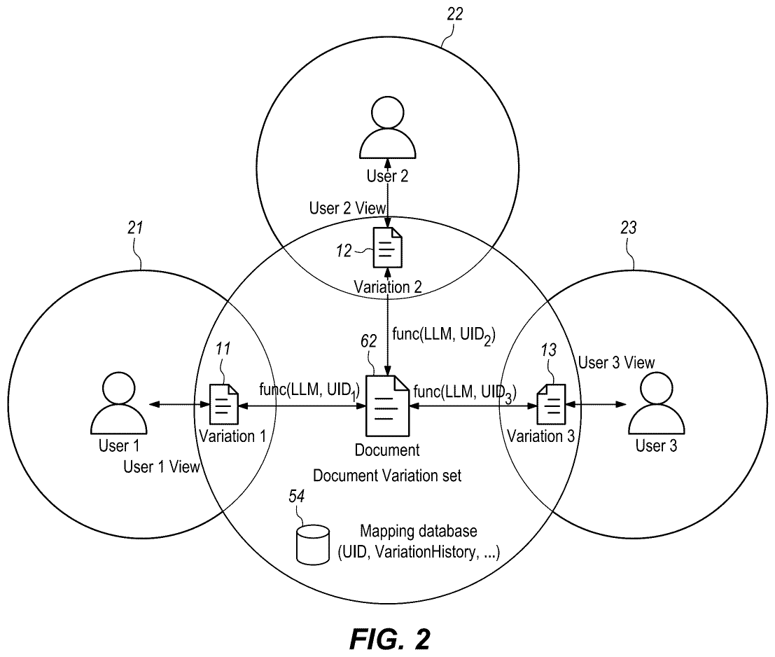

FIG. 2 is a diagram illustrating the generation of three unique document variants 11-13 of a single source document 62 for sharing with three authorized users 21-23 according to some embodiments. Whether each user 21-23 has requested access to the source document 62 or someone has instructed the filesharing application send the source document 62 to each user 21-23, the source document 62 is provided to a large language model (LLM) along with a prompt to paraphrase one or more portion of the source document to generate a unique document variant for each user 21-23. Accordingly, the LLM generates the unique document variants 11-13 and the filesharing applications provides the first unique document variant 11 to the first user 21, the second unique document variant 12 to the second user 22, and the third unique document variant 13 to the third user 23. A mapping database 54 (also referred to as the document variant/user identification records module 54 in FIG. 1) includes a record of the identity of each unique document variant 11-13 and the identity of the user 21-23 that was provided with the unique document variant. In the example of FIG. 2, the database would store a first record identifying the first unique document variant 11 and the first user 21, a second record identifying the second unique document variant 12 and the second user 22, and a third record identifying the third unique document variant 13 and the third user 23. Should any of these unique document variants 11-13 be leaked and discovered (i.e., a target document), the target document may be compared with the records of the databased to determine the identity of the user whose unique document variant was involved in the leak.

As a specific simplified example using a source document with only a single paragraph, the following text may form the source document:

### Source Document:

One effective business strategy that companies often employ is diversification. By expanding their product or service offerings into new markets or industries, businesses can reduce risk and capture new sources of revenue. Diversification can take several forms, such as related diversification, where products or services are complementary to existing offerings, or unrelated diversification, where entirely new markets are explored. This strategy not only helps in spreading risk but also enables companies to leverage their existing strengths and resources in innovative ways, fostering long-term growth and sustainability in a competitive landscape. Successful implementation of a diversification strategy requires thorough market research, strategic planning, and a keen understanding of customer needs and market dynamics.

Prompting the LLM to produce three unique document variants of the source document may lead to generation of the following:

### First Unique Document Variant (Provided to the First User);

An effective business approach frequently utilized involves diversification, where companies expand their range of products or services into new markets or industries. This strategy aims to reduce risk and capture additional revenue sources by either introducing complementary offerings (related diversification) or entering entirely new markets (unrelated diversification). Diversification leverages existing strengths and resources to foster sustained growth and competitiveness. Successful execution demands meticulous market analysis, strategic planning, and a deep understanding of customer preferences and market conditions.

### Second Unique Document Variant (Provided to the Second User):

A common and successful business strategy is diversification, where companies expand their product or service offerings into new markets or industries. This approach aims to minimize risk and tap into additional revenue streams by either introducing related products/services or entering completely new markets. Diversification allows businesses to leverage their existing strengths and resources to sustain growth and stay competitive. Effective implementation requires thorough market research, strategic planning, and a solid understanding of customer needs and market dynamics.

### Third Unique Document Variant (Provided to the Third User):

Diversification is a widely used business strategy where companies broaden their product or service offerings into new markets or industries. The goal is to mitigate risk and capture more revenue by introducing related products/services or entering entirely different markets. This approach allows businesses to utilize their current strengths and resources for sustained growth and competitiveness. Successful execution necessitates thorough market research, strategic planning, and a deep understanding of customer demands and market dynamics.

These three unique document variants have a large number of modifications (i.e., a low similarity) that are spread from beginning to end of the unique document variants. Unique document variants could have fewer modifications or differences and still be distinguishable from each other for identifying the user associated with each variant. Furthermore, each document variant could have uniquely paraphrased portions that occur in separate portions of the document, such as paraphrasing only the first sentence of the source document to produce a first unique document variant, paraphrasing only the second sentence of the source document to produce a second unique document variant, and paraphrasing only the third sentence of the source document to produce a third unique document variant. There are many ways to form a unique document variant using paraphrasing. However, each of the unique document variants still conveys the same meaning as the source document.

Should any of the three unique document variants be used in an unauthorized manner, such as leaking the document to the public, the leaked (target) document may be compared to each of the three unique document variants stored in a database. Once a record with the matching uniquely paraphrased portion of the unique document variant is identified, the same record will include the identity of the user that was involved in the unauthorized use.

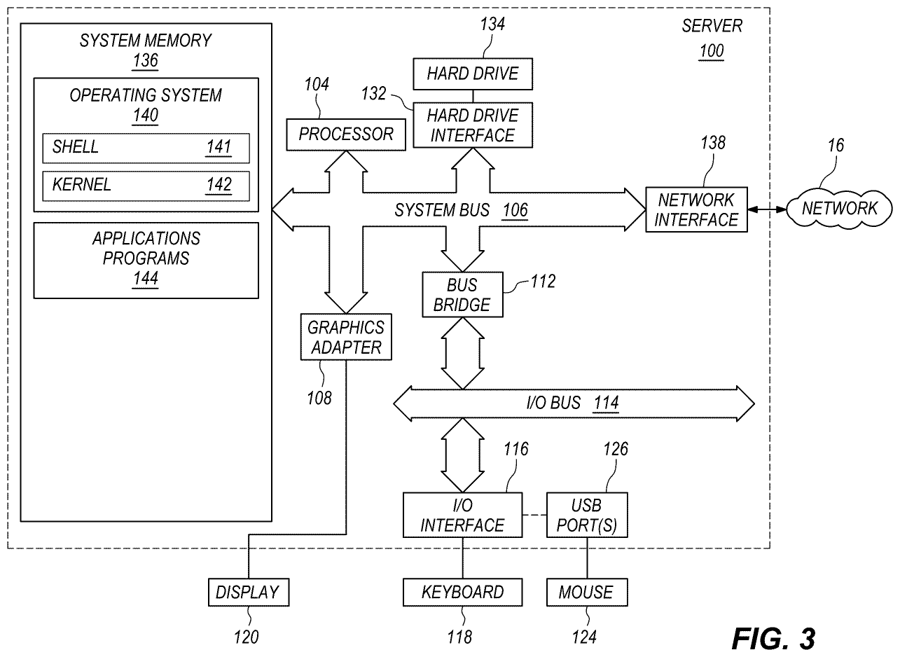

FIG. 3 is a diagram of a computing device or server 100 according to some embodiments. The computing device or server 100 may be representative of the users' computing devices 21-24, representative of the filesharing server 30 that runs the filesharing application 40 and user (leak source) identification application or logic 60, or even a server hosting the remote large language model (LLM) 60.

The server 100 includes a processor unit 104 that is coupled to a system bus 106. The processor unit 104 may utilize one or more processors, each of which has one or more processor cores. An optional graphics adapter 108, which may or may not drive/support an optional display 120, is also coupled to system bus 106. The graphics adapter 108 may, for example, include a graphics processing unit (GPU). The system bus 106 may be coupled via a bus bridge 112 to an input/output (I/O) bus 114. An I/O interface 116 is coupled to the I/O bus 114, where the I/O interface 116 affords a connection with various optional I/O devices, such as a camera 110, a keyboard 118 (such as a touch screen virtual keyboard), and a USB mouse 124 via USB port(s) 126 (or other type of pointing device, such as a trackpad). As depicted, the computer 100 is able to communicate with other computing devices over a network, such as the network(s) 16, using a network adapter or network interface controller 138.

A hard drive interface 132 is also coupled to the system bus 106. The hard drive interface 132 interfaces with a hard drive 134. In a preferred embodiment, the hard drive 134 may communicate with system memory 136, which is also coupled to the system bus 106. The system memory may be volatile or non-volatile and may include additional higher levels of volatile memory (not shown), including, but not limited to, cache memory, registers and buffers. Data that populates the system memory 136 may include the operating system (OS) 140 and application programs 144. The hardware elements depicted in the server 100 are not intended to be exhaustive, but rather are representative.

The operating system 140 includes a shell 141 for providing transparent user access to resources such as application programs 144. Generally, the shell 141 is a program that provides an interpreter and an interface between the user and the operating system. More specifically, the shell 141 may execute commands that are entered into a command line user interface or from a file. Thus, the shell 141, also called a command processor, is generally the highest level of the operating system software hierarchy and serves as a command interpreter. The shell may provide a system prompt, interpret commands entered by keyboard, mouse, or other user input media, and send the interpreted command(s) to the appropriate lower levels of the operating system (e.g., a kernel 142) for processing. Note that while the shell 141 may be a text-based, line-oriented user interface, the present invention may support other user interface modes, such as graphical, voice, gestural, etc.

As depicted, the operating system 140 also includes the kernel 142, which includes lower levels of functionality for the operating system 140, including providing essential services required by other parts of the operating system 140 and application programs 144. Such essential services may include memory management, process and task management, disk management, and mouse and keyboard management. In addition, the computer server 100 may include application programs 144 stored in the system memory 136. Where the server 100 represents a filesharing server 30 of FIG. 1, the application programs 144 may include the filesharing application 40 and the user (leak source) identification application or logic 50.

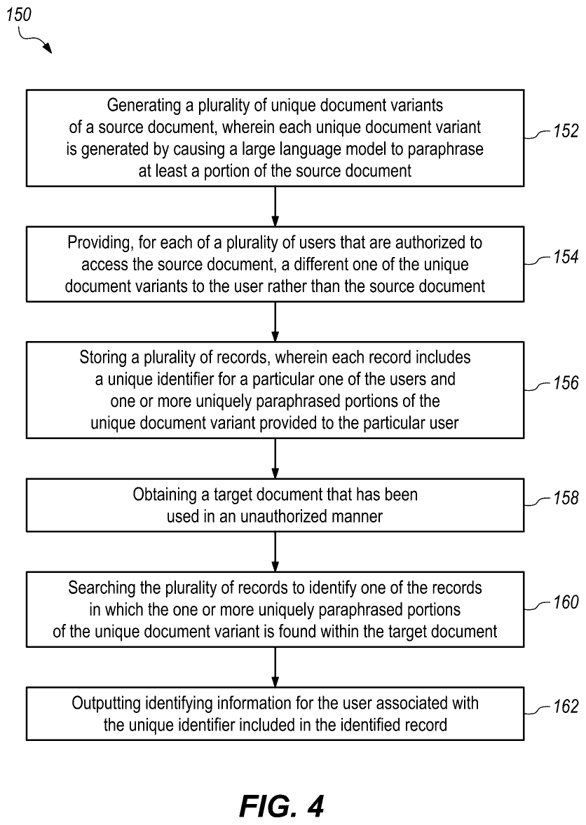

FIG. 4 is a flowchart of operations 150 according to some embodiments. Operation 152 includes generating a plurality of unique document variants of a source document, wherein each unique document variant is generated by causing a large language model to paraphrase at least a portion of the source document. Operation 154 includes providing, for each of a plurality of users that are authorized to access the source document, a different one of the unique document variants to the user rather than the source document. Operation 156 includes storing a plurality of records, wherein each record includes a unique identifier for a particular one of the users and one or more uniquely paraphrased portions of the unique document variant provided to the particular user. Operation 158 includes obtaining a target document that has been used in an unauthorized manner. Operation 160 includes searching the plurality of records to identify one of the records in which the one or more uniquely paraphrased portions of the unique document variant is found within the target document. Operation 162 includes outputting identifying information for the user associated with the unique identifier included in the identified record.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising a non-transitory computer readable medium and program instructions embodied therein, the program instructions being configured to be executable by a processor to cause the processor to perform operations comprising:
generating a plurality of unique document variants of a source document, wherein each unique document variant is generated by causing a language model to paraphrase at least a portion of the source document;
providing, for each of a plurality of users that are authorized to access the source document, a different one of the unique document variants to the user rather than the source document;
storing a plurality of records, wherein each record includes a unique identifier for a particular one of the users and one or more uniquely paraphrased portions of the unique document variant provided to the particular user;
obtaining a target document that has been used in an unauthorized manner;
searching the plurality of records to identify one of the records in which at least one of the one or more uniquely paraphrased portions of the unique document variant is found within the target document; and
outputting identifying information for the user associated with the unique identifier included in the identified record.

2. The computer program product of claim 1, wherein the operation of searching the plurality of records to identify one of the records in which the one or more uniquely paraphrased portions of the unique document variant are found within the target document includes:
searching the plurality of records to identify one of the records in which the unique document variant matches the target document.

3. The computer program product of claim 1, further comprising:
automatically modifying a network or server access permission or setting for the user associated with the unique identifier included in the identified record.

4. The computer program product of claim 1, further comprising:
storing the source document on a data storage device;
presenting, via a user interface, an indicator suggesting that the source document is accessible to the plurality of users; and
receiving user input from a given user among the plurality of users, wherein the user input is a request to access the source document, and where the one of the unique document variants is provided to the given user rather than the source document in response to receiving the user input.

5. The computer program product of claim 4, wherein the operation of generating the plurality of unique document variants of the source document includes generating one unique document variant for each of the plurality of users that are authorized to access the source document without receiving further user input from each of the plurality of users.

6. The computer program product of claim 4, wherein the one of the unique document variants that is provided to the given user is generated in response to receiving the user input that requests to access the source document.

7. The computer program product of claim 4, the operations further comprising:
forming a user interface enabling any of the plurality of users to submit the user input, wherein the one of the unique document variants is provided to the given user by downloading the unique document variant to a computing device operated by the given user.

8. The computer program product of claim 1, further comprising:
storing the source document on a data storage device; and
receiving user input requesting that the source document be sent to one or more of the plurality of users, wherein, for each of the one or more users, a different one of the unique document variants is provided to the user by sending the one of the unique document variants in an electronic message.

9. The computer program product of claim 1, wherein each record includes a complete copy of the unique document variant provided to the particular user.

10. The computer program product of claim 1, wherein each record includes the one or more uniquely paraphrased portions of the unique document variant but not a complete copy of the unique document variant provided to the particular user.

11. The computer program product of claim 10, wherein the one or more uniquely paraphrased portions of the unique document variant includes only the difference between the unique document variant and the source document.

12. The computer program product of claim 1, wherein the operation of generating the plurality of unique document variants of the source document includes providing a seed value to an algorithm that uses the seed value to produce an output that controls how the language model with paraphrase the at least a portion of the source document, and wherein the one or more portion uniquely paraphrased portions of the unique document variant is included each record by including the seed value.

13. The computer program product of claim 12, wherein the operation of searching the plurality of records to identify one of the records in which the one or more uniquely paraphrased portions of the unique document variant is found within the target document includes regenerating the one or more uniquely paraphrases portions of the unique document variant by inputting the seed value of a record into the algorithm and providing the output and the source document to the language model.

14. The computer program product of claim 1, further comprising:
storing, in each of the plurality of records, a hash of the unique document variant provided to the user identified in the record; and
calculating a hash of the target document, wherein the operation of searching the plurality of records to identify one of the records in which the one or more uniquely paraphrased portions of the unique document variant is found within the target document includes searching the plurality of records to identify one of the records in which the hash of the unique document variant matches the hash of the target document.

15. The computer program product of claim 1, further comprising:
tracking, for any of the plurality of users that contributed to the source document, one or more portions of the source document that are contributed by the user, wherein generating the plurality of unique document variants of the source document includes generating, for each of the plurality of users that contributed to the source document, the unique document variant provide to the user by causing the language model to paraphrase only those portions of the source document that were contributed by another user.

16. The computer program product of claim 1, further comprising:
forming a digital signature for each unique document variant, wherein the operation of providing, for each of a plurality of users that are authorized to access the source document, a different one of the unique document variants to the user rather than the source document includes providing the digital signature to the user along with the unique document variant.

17. The computer program product of claim 1, further comprising:
determining an extent to which the source document will be paraphrased during generating of the one or more of the document variants based upon the number of users that are authorized to access the source document, a level of confidentiality assigned to the source document, and/or a probability that the source document will be used in an unauthorized manner, wherein the operation of causing the language model to paraphrase at least a portion of the source document includes instructing the language model to paraphrase the at least a portion of the source document to the determined extent.

18. The computer program product of claim 1, further comprising:
determining an extent to which the source document will be paraphrased during generating of the one or more of the document variants based upon a level of interaction among the plurality of users that are authorized to access to the source document, wherein the operation of causing the language model to paraphrase at least a portion of the source document includes instructing the language model to paraphrase the at least a portion of the source document to the determined extent.

19. The computer program product of claim 1, further comprising:
determining the total number of words in the source document; and
randomly generate a number (N) between one and the total number of words in the source document, wherein causing the language model to paraphrase at least a portion of the source document includes causing the language model to replace the Nth word in the source document with a synonym, paraphrase the sentence that includes the Nth word in the source document, and/or paragraph the paragraph that includes the Nth word in the source document.

20. The computer program product of claim 1, further comprising:
establishing a similarity threshold between the unique document variants;
determining a similarity index between a plurality of pairings of the unique document variants; and
causing, in response to one of the pairings of the unique document variants having a similarity index greater than the similarity threshold, the language model to further paraphrase one or more of the unique document variants in the pairing.
